(19) United States
(12) Patent Application Publication
(10) Pub. No.: US 2008/0104361 A1
(43) Pub. Date: May 1, 2008

(54) Storage Device, Memory Managing Apparatus, Memory Managing Method, and Program

(76) Inventor: Hiroshi Ippongi, Miyagi (JP)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/628,373

(22) PCT Filed: Mar. 30, 2006
(86) PCT No.: PCT/JP06/07265

§ 371 Date: Aug. 30, 2007

(30) Foreign Application Priority Data
Mar. 31, 2005 (JP) 2005-104207

(51) Int. Cl. G06F 12/16

(52) U.S. Cl. 711/206

(57) ABSTRACT

A flash memory stores current and past BPTs (Block Pointer Tables) indicating correspondence between physical addresses and logical addresses of blocks. At the time of writing of user data, which requires that a new current BPT after this writing be written in a vacant block, a controller updates the current BPT to the new current BPT to include information indicating the order at which that vacant block is used for storing the BPT, the location of the BPT older by one, whether or not the block previously used for storing the BPT is a defective block. At the next initialization, the controller performs correction, etc. of a current BPT based on these pieces of information. In a case where any of these pieces of information is missing, the controller specifies the content of a current BPT based on the other available pieces of information.

TECHNICAL FIELD

The present invention relates to a data processing system utilizing a storage device, and a computer-readable program for accessing the storage medium device.

BACKGROUND ART

EEPROM (Electrically Erasable/Programmable Read Only Memory) flash memories are used as storage media accessible (data readable and erasable) by a computer or the like.

Data erasion is done in a flash memory in a unit of a predetermined storage capacity (generally referred to as “block”).

Among flash memories, particularly NAND type ones might be seized with occurrence of a defective block, in which data storage cannot be performed properly. It is difficult to fully prevent occurrence of such defective blocks in the manufacturing process. Hence, conventionally, apart from physical addresses assigned to the respective blocks, continuous logical addresses are dynamically assigned to normal blocks, and an address translation table indicating the correspondence between the physical addresses and the logical addresses is generated. Thus, if the flash memory is accessed in the unit of logical block, this address translation table helps in avoiding the procedure for external memory access becoming complicated due to the actual physical addresses becoming discontinuous.

In many cases, the address translation table is used while stored in a separate memory from the flash memory. However, in some cases, the address translation table may be stored in the storage area of the flash memory itself, with a view to avoiding complication of regenerating the address translation table again and again each time the flash memory starts to be used (for example, Unexamined Japanese Patent Application KOKAI Publication No. 2000-11677).

### DISCLOSURE OF INVENTION

However, the apparatus to access the flash memory might suspend an operation for updating the address translation table or might run abnormally due to a power failure, etc. during the updating operation. In such cases, there is a high risk that the flash memory storing the address translation table therein will not be able to be read or written properly after such an event.

The present invention was made in view of the above-described circumstance, and an object of the present invention is to provide a storage device, a memory managing apparatus, a memory managing method, and a program for enabling data reading and writing to be performed properly even after a trouble which occurs while the address translation table is being updated.

A storage device according to a first aspect of the present invention comprises:

a storage unit (11) which includes a plurality of memory blocks for storing user data each of which is assigned a physical address, and stores a current address translation table indicating correspondence between the physical addresses of the memory blocks and logical addresses thereof; and

a writing unit (12) which receives user data to be written and a logical address, specifies a vacant page in which the user data can be stored, from pages which constitute a memory block, writes the user data to be written in the specified vacant page, and stores a new current address translation table indicating correspondence between the physical addresses and logical addresses of the memory blocks after the user data is written, in said storage unit (11),

wherein:

the storage unit (11) continuously stores a past address translation table which has been the current address translation table until immediately before the new current address translation table is stored; and

the writing unit (12) adds previous table information indicating a page in which the past address translation table is stored to the new current address translation table, and stores the resultant new current address translation table in the storage unit (11).

According to the present storage device, because information specifying the location of a past address translation table is saved, even if the current address translation table has a trouble, it is possible to determine the correct content of the current address translation table by using the current and past address translation tables. Accordingly, even if a trouble occurs while the address translation table is being updated, the reading and writing operations to be performed thereafter can be performed properly.

If the writing unit (12) is designed to specify a location of the past address translation table based on the previous table information, and to correct a content of the current address translation table based on the past address translation table whose location is specified, in a case where the current address translation table has a trouble, it is possible to determine the correct content of the current address translation table by using the current and past address translation tables.

If the writing unit (12) is designed to specify any logical address whose correspondence with a physical address in an address translation table older by one, which is specified based on the previous table information, is different from whose correspondence with a physical address in the current address translation table by referring to the these address translation tables, determine which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, correct the current address translation table so as to indicate the determined correct correspondence, in a case where the current address translation table has a trouble, it is possible to determine the correct content of the current address translation table by using the current and past address translation tables.

In a case where the writing unit (12) stores the new current address translation table in a memory block which has not stored any address translation table yet, the writing unit (12) may add block use order information indicating an order at which the memory block is started to be used as a memory block for storing an address translation table to the new current address translation table, and store the resultant new current address translation table in the storage unit (11).

With this configuration, even in a case where the previous table information has not been stored correctly, it is possible to correctly specify the past address translation table by using the block use order information.

If the writing unit (12) is designed to specify a location of the past address translation table based on the block use order information, and to correct a content of the current address translation table based on the past address translation table whose location is specified, even in a case where the current address translation table has a trouble, and further, the previous table information is not correctly stored, the past address translation table is specified correctly with the use of the block use order information, and the correct content of the current address translation table is determined with the use of the current and past address translation tables.

If the writing unit (12) is designed to specify any logical address whose correspondence with a physical address in an address translation table older by one, which is specified based on the block use order information, is different from whose correspondence with a physical address in the current address translation table by referring to the these address translation tables, determine which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, correct the current address translation table so as to indicate the determined correct correspondence, in a case where the current address translation table has a trouble, even in a case where the current address translation table has a trouble, and further, the previous table information is not correctly stored, the past address translation table is specified correctly with the use of the block use order information, and the correct content of the current address translation table is determined with the use of the current and past address translation tables.

The writing unit (12) may store an address translation table in a vacant page in accordance with an order of each page in a memory block assigned to each page, and when the writing unit (12) stores the new current address translation table in a memory block which has not stored any address translation table yet, the writing unit (12) adds previous table storing block status information indicating whether a memory block which stores the past address translation table is a defective block or not, to the new current address translation table, and stores the resultant new current address translation table in the storage unit (11).

With this configuration, even in a case where the previous table information has not been stored correctly, the memory block in which the past address translation table is stored becomes a defective block, and the address translation table is not stored in a page assigned the last order, it is possible to correctly specify the past address translation table by using the block use order information and the previous table storing block status information.

If the writing unit (12) is designed to specify a location of the past address translation table based on the block use order information and the previous table storing block status information, and to correct a content of the current address translation table based on the past address translation table whose location is specified, even in a case where the current address translation table has a trouble, the previous table information is not correctly stored, the memory block in which the past address translation table is stored becomes a defective block, and further, the address translation table is not stored in a page assigned the last order, the past address translation table is specified correctly with the use of the block use order information and the previous table storing block status information, and the correct content of the current address translation table is determined with the use of the current and past address translation tables.

If the writing unit (12) is designed to specify any logical address whose correspondence with a physical address in an address translation table older by one, which is specified based on the block use order information and the previous table storing block status information, is different from whose correspondence with a physical address in the current address translation table by referring to the these address translation tables, determine which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, correct the current address translation table so as to indicate the determined correct correspondence, even in a case where the current address translation table has a trouble, the previous table information is not correctly stored, the memory block in which the past address translation table is stored becomes a defective block, and further, the address translation table is not stored in a page assigned the last order, the past address translation table is specified correctly with the use of the block use order information and the previous table storing block status information, and the correct content of the current address translation table is determined with the use of the current and past address translation tables.

A memory managing apparatus according to a second aspect of the present invention is an apparatus for storing user data to be written, in a memory (11) including a plurality of memory blocks for storing the user data each of which memory blocks is assigned a physical address, and for storing in the memory (11) a current address translation table indicating correspondence between the physical addresses of the memory blocks and logical addresses thereof, the apparatus comprising:

a user data writing unit (12) which receives user data to be written and a logical address, specifies a vacant page in which the user data can be stored, from pages constituting a memory block, and writes the user data to be written, in the specified vacant page; and

a table writing unit (12) which stores a new current address translation table indicating correspondence between the physical addresses and logical addresses of the memory blocks after writing by the user data writing unit is performed, in the memory (11),

wherein:

the memory (11) continuously stores a past address translation table which has been the current address translation table until immediately before the new current address translation table is stored; and

the table writing unit (12) adds previous table information indicating a page in which the past address translation table is stored to the new current address translation table, and stores the resultant new current address translation table in the memory (11).

According to the present memory managing apparatus, because information specifying the location of a past address translation table is saved, even if the current address translation table has a trouble, it is possible to determine the correct content of the current address translation table by using the current and past address translation tables. Accordingly, even if a trouble occurs while the address translation table is being updated, the reading and writing operations to be performed thereafter can be performed properly.

A memory managing method according to a third aspect of the present invention is a method for storing user data to be written, in a memory (11) including a plurality of memory blocks for storing the user data each of which memory blocks is assigned a physical address, and for storing in the memory (11) a current address translation table indicating correspondence between the physical addresses of the memory blocks and logical addresses thereof, the method comprising:

a user data writing step (S300) of receiving user data to be written and a logical address, specifying a vacant page in which the user data can be stored, from pages constituting a memory block, and writing the user data to be written, in the specified vacant page; and

a table writing step (S200) of storing a new current address translation table indicating correspondence between the physical addresses and logical addresses of the memory blocks after writing at the user data writing step (S300) is performed, in the memory (11),

wherein:

the memory (11) continuously stores a past address translation table which has been the current address translation table until immediately before the new current address translation table is stored; and

at the table writing step (S200), previous table information indicating a page in which the past address translation table is stored is added to the new current address translation table, and the resultant new current address translation table is stored in the memory(11).

According to the present memory managing method, because information specifying the location of a past address translation table is saved, even if the current address translation table has a trouble, it is possible to determine the correct content of the current address translation table by using the current and past address translation tables.

Accordingly, even if a trouble occurs while the address translation table is being updated, the reading and writing operations to be performed thereafter can be performed properly.

A program according to a fourth aspect of the present invention is a program for controlling a computer to function as a memory managing apparatus for storing user data to be written, in a memory (11) including a plurality of memory blocks for storing the user data each of which memory blocks is assigned a physical address, and for storing in the memory (11) a current address translation table indicating correspondence between the physical addresses of the memory blocks and logical addresses thereof, the apparatus comprising:

a user data writing unit (12) which receives user data to be written and a logical address, specifies a vacant page in which the user data can be stored, from pages constituting a memory block, and writes the user data to be written, in the specified vacant page; and

a table writing unit (12) which stores a new current address translation table indicating correspondence between the physical addresses and logical addresses of the memory blocks after writing by the user data writing unit is performed, in the memory (11),

wherein:

the memory (11) continuously stores a past address translation table which has been the current address translation table until immediately before the new current address translation table is stored; and

the table writing unit (12) adds previous table information indicating a page in which the past address translation table is stored to the new current address translation table, and stores the resultant new current address translation table in the memory (11).

According to a computer executing the present program, because information specifying the location of a past address translation table is saved, even if the current address translation table has a trouble, it is possible to determine the correct content of the current address translation table by using the current and past address translation tables. Accordingly, even if a trouble occurs while the address translation table is being updated, the reading and writing operations to be performed thereafter can be performed properly.

According to the present invention, a storage device, a memory managing apparatus, memory managing method, and a program capable of enabling data reading and writing o be performed properly even after a trouble which occurs while the address translation able is being updated.

### BRIEF DESCRIPTION OF DRAWINGS

These objects and other objects and advantages of the present invention will become more apparent upon reading of the following detailed description and the accompanying drawings in which:

FIG. 1 is a block diagram showing the structure of a storage system according to an embodiment of the present invention;

FIG. 2 is a diagram exemplarily showing the logical structure of the storage area of a flash memory;

FIG. 3 is a diagram exemplarily showing the data structure of a BPT;

FIG. 4 is a diagram exemplarily showing the data structure of a BSI;

FIG. 5 is a flowchart showing an initial process;

FIG. 6 is a flowchart showing a data writing process;

FIG. 7 is a flowchart showing an old user data reading process;

FIG. 8 is a flowchart showing a BPT updating process;

FIG. 9 is a continuation of the flowchart showing the BPT updating process; and

FIG. 10 is a flowchart showing an old BPT erasing process.

### BEST MODE FOR CARRYING OUT THE INVENTION

An embodiment of the present invention will now be explained with reference to the drawings, by employing a storage system having a flash memory as an example.

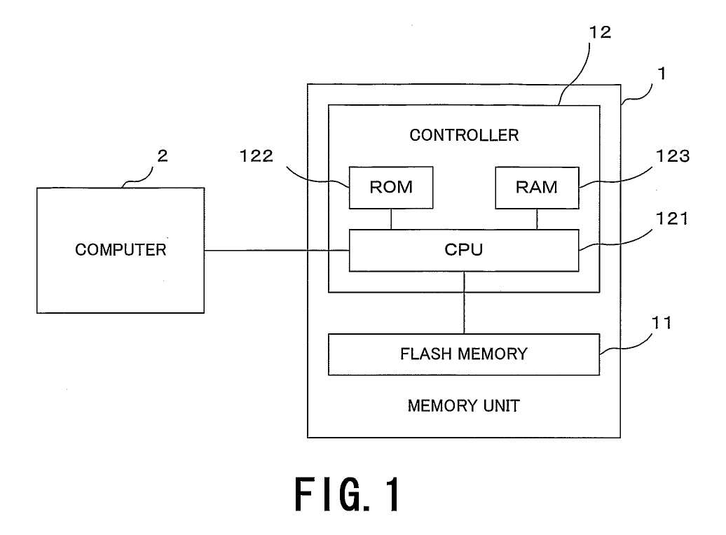

FIG. 1 is a block diagram showing the physical structure of a storage system according to an embodiment of the present invention. As shown in FIG. 1, the storage system comprises a memory unit 1 and a computer 2.

The memory unit 1 is connected to the computer 2. The memory unit 1 and the computer 2 may be fixedly connected.

The memory unit 1 may be detachably attached to the computer 2 via a slot for relaying a bus, which is based on, for example, PC Card Standard.

The memory unit 1 comprises a flash memory 11 and a controller 12.

The flash memory 11 responds to an access by the controller 12. The flash memory 11 stores data supplied from the controller 12, supplies stored data to the controller 12, or erases stored data.

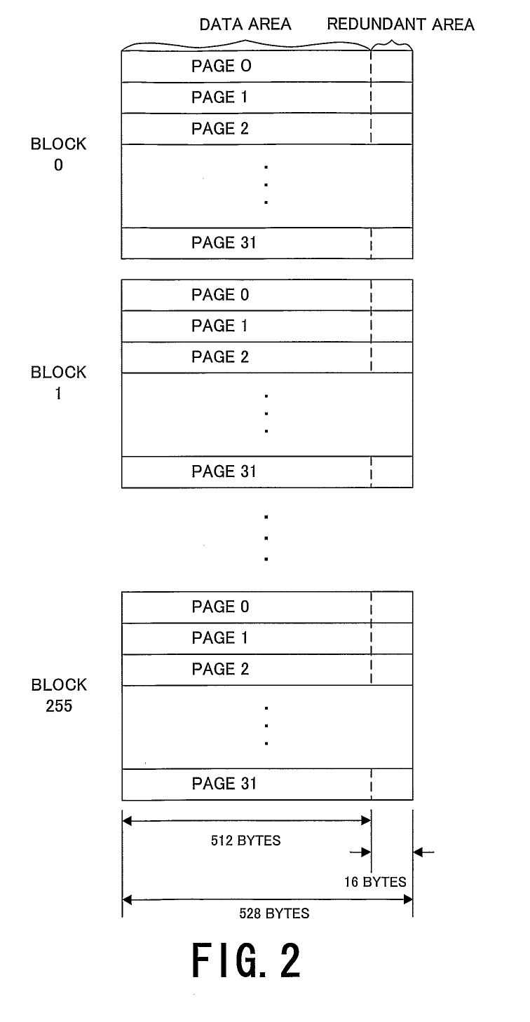

The storage area possessed by the flash memory 11 is constituted by, for example, 8,129 pages, as shown in FIG. 2. Each page has a storage capacity of 528 bytes. Page addresses of 0 to 8191 are serially assigned to the pages. Memory cells included in each age is assigned address numbers of 0 to 527 serially.

Each block is constituted by 32 pages from the top sequentially. Each block has a storage capacity of 16 kilobytes. The whole storage area of the flash memory 11 is constituted by 256 blocks. The blocks are assigned physical block addresses of 0 to 255 from the top serially.

As shown in FIG. 2, each page includes a data area from the top, and a redundant area. The data area occupies an area of 512 bytes, and the redundant area occupies an area of 16 bytes.

User data is stored in the data area. User data is data which is supplied from the computer 2 to be written, or which is supplied to the computer 2. An error correction code, a defective block flag, etc. are stored in the redundant area. An error correction code is for correcting the content of the user data in a case where the content of the user data is destroyed. A defective block flag is a flag to be stored in a redundant area of a page which belongs to a block in which data cannot be read or written properly.

Further, the value of a logical block address assigned to each block is stored in the redundant area of each page belonging to that block.

The logical block address is recognized by the flash memory 11 as a unit for reading or writing data in the flash memory 11.

The total number of blocks to which logical block addresses are assigned is a predetermined number smaller than the total number (256 blocks) of blocks physically included in the flash memory 11, for example, 250 blocks.

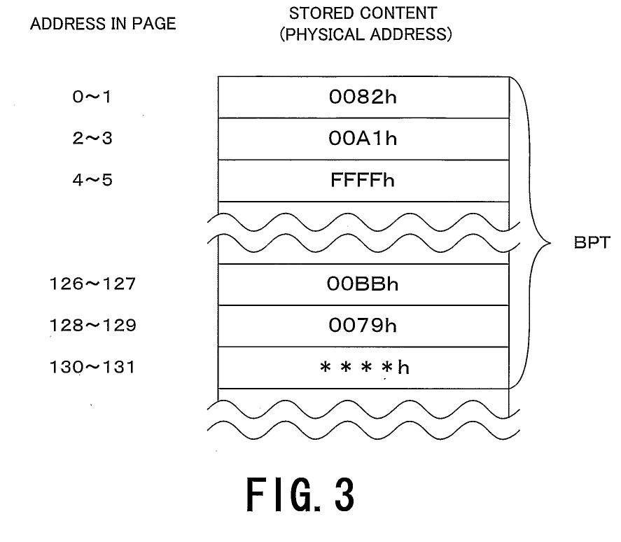

The data area is also used for storing a BPT (Block Pointer Table). The BPT is data to be stored in accordance with a later-described process performed by the controller 12. The BPT comprises, for example, a table shown in FIG. 3. The table associates the logical block addresses and physical block addresses of the blocks constituting the flash memory 11 with each other.

An error correction code, etc. are stored in the redundant area of the page in which the BPT is stored. The error correction code is for correcting the content of the BPT.

At the time the storage system is activated, the controller 12 determines whether the correspondence between the logical block addresses and the physical block addresses recorded in the BPT is different from the actual correspondence of data by comparing the BPT with a past BPT. If it is determined that the recorded correspondence is different from the actual correspondence, the controller 12 generates a new BPT indicating the correct correspondence by performing a later-described process. The controller 12 stores the generated new BPT in a data area of the flash memory 11.

User data is not to be stored in a block (hereinafter referred to as BPT block) including a page in which the BPT is stored. The range of the logical block address of the BPT block and the range of the logical block addresses of the blocks in which user data may be stored do not overlap each other.

One BPT has a storage capacity of equal to or smaller than the data area (512 bytes) of one page of the flash memory 11. One BPT is stored in the data area of one page.

When the memory unit 1 is manufactured and shipped, one block (initial BPT block) is generated, which has at its top, a page in which the first BPT is stored. In the page in which the initial BPT is stored, an initial value of a writing counter, and an initial value of a previous page pointer are generated and stored. In the redundant area of a page constituting the initial BPT block, a logical address that is out of the range of logical addresses of other blocks in which user data is to be stored, is stored. Further, also in a case where the user performs an operation involving erasion of all the content of flash memory 11 to get the memory unit 1 back to the same state as it was when shipped, one initial BPT block is generated likewise.

Thereafter, each time a new BPT is generated, the controller 12 stores the new BPT in the succeeding pages sequentially, in the same block. That is, the BPT is stored in the first page among the pages in which no BPT has been stored in the block.

Meanwhile, the controller 12 does not immediately erase the old BPT whose data partially no longer indicates the correct correspondence. The controller 12 keeps storing the new BPT and old BPTs in the data areas, until the total number of BPTs reaches the same number as the number of pages included in one block at the maximum. That is, in the flash memory 11 having the storage area shown in FIG. 2, the maximum of 32 BPTs are retained.

The BPT includes a plurality of storage areas having serial address numbers. These storage areas are associated in one-to-one correspondence with logical block addresses. In a storage area associated with one logical block address, a physical block address associated with that logical block address is stored.

Specifically, FIG. 3 exemplarily shows the data structure of the BPT. In FIG. 3, a storage area having 2 bytes in total whose address is (2·n) and {(2·n)+1} (where n being an integer equal to or larger than 0 and equal to or smaller than 255) is associated with a logical block address n. Further, assume that a value “0082h” is stored in a storage area having an address of 0 to 1. In this case, the block whose physical block address is 0082h is associated with 0001h as its logical block address.

However, in a case where the value stored in this storage area represents a predetermined value (for example, a value “FFFFh” as shown in FIG. 3), it means that the logical block address associated with the storage area in which the predetermined value is stored is associated with no physical block address.

The controller 12 generates a new BPT when necessity arises. However, if the page which stores the BPT older by one than the BPT to be newly generated is the last page in the block, the controller 12 searches for a vacant block first. Then, the controller 12 uses the searched-out one vacant block as the new BPT block. The controller 12 generates a new BPT in the top page of the new BPT block. The controller 12 stores a new previous page pointer, previous block writing failure flag, and writing counter in the top page.

The previous page pointer indicates a physical page address of the page which stores the BPT older by one than the BPT in which the previous page pointer is stored (the physical page address is the combination of the physical block address of the block including the page, and the page address of the page in that block). The value of the previous page pointer is, for example, “FFFFh”.

The previous block writing failure flag is a flag showing whether the block storing the BPT older by one than the current BPT (hereinafter, this block is referred to as previous block) is a postnatally defective block or not.

The initial value of the previous block writing failure flag is, for example, “Fh”, which indicates that wiring has been performed correctly. The value of the previous block writing failure flag is not changed in a case where writing in the previous block has been performed properly. The value of the previous block writing failure flag is changed to “Oh” in a case where writing in the previous block has failed.

The writing counter indicates the order at which the block which stores the BPT storing this writing counter is started to be used as the block to store the BPT. The initial value of the writing counter is arbitrary. The value of the writing counter may be assigned cyclically. That is, when the value of the writing counter that is stored most lately becomes a predetermined value (for example, 255), the new value of the writing counter to be stored next may return to the initial value.

The flash memory 11 is instructed by the controller 12 of the memory unit 1 to erase data in a specific block. The flash memory 11 resets the stored contents of all the memory cells included in that specific block (for example, changes the stored values in the memory cells to “1” in a case where the flash memory 11 is a NAND type flash memory).

The flash memory 11 is checked when shipped, as to whether each and every block can be read or written properly. A flag (defective block flag) indicating that the block cannot be used is written in the redundant area of each page included in a block which cannot be read or written properly. The block in which the defective block flag is writen is prohibited from being used. Also in a case where a block becomes unable to be read or written properly while the flash memory 11 is being used, a defective block flag is likewise written, to prohibit access to that block thereafter.

When shipped, the memory unit 1 initializes the pages (for example, changes the logical values of all bits to “1”) included in the blocks of the flash memory 11 to which logical block addresses are assigned (note that these blocks do not include the blocks having the above-described defective block flag). The memory unit 1 generates a BPT block including one BPT page in the flash memory 11. All the values in the logical/physical translation table in this BPT page are set to the initial value (“FFFFh”). The value of the previous page pointer of this BPT page is set to the initial value “FFFFh”. The previous block writing failure flag of this BPT page is set to the initial value “Fh”. The value of the writing counter of this BPT page is set to the initial value “0”. Further, a logical block address having a value (for example, “100 h”) which is larger than the total number of blocks (256 blocks) physically included in the flash memory 11 is stored in the redundant area of the BPT page.

The controller 12 comprises a CPU (Central Processing Unit) 121, a ROM (Read Only Memory) 122, and a RAM (Random Access Memory) 123, as shown in FIG. 1.

The CPU 121 is connected to the ROM 122, the RAM 123, and the flash memory 11. The CPU 121 is also connected to the computer 2. The CPU 121 and the computer 2 may be fixedly connected. This connection may be, for example, made detachably via the aforementioned slot of the computer 2.

The CPU 121 performs the processes to be described later in accordance with a program in the ROM 122 pre-stored therein by the manufacturer of the controller 12.

The CPU 121 executes an instruction when it obtains the instruction from the computer 2 constituting the accessing apparatus. The instructions to be executed by the CPU 121 include an instruction for accessing the flash memory 11.

The RAM 123 is constituted by, for example, an SRAM (Static RAM) or the like. The RAM 123 serves as a work area or a saving memory area of the CPU 121. The saving memory area is a storage area for retaining (saving) data for one page for a limited period of time, in a later-described data writing process. The data to be saved may be, for example, user data and the BPT.

Further, the RAM 123 stores a BSI (Block Search Index) which is generated by the CPU 121.

The BSI stores information indicating which of the plurality of blocks included in the flash memory 11 is a vacant block (i.e., a block in a reset state).

The BSI is generated in accordance with a later-described process of the controller 12, each time the storage system is activated.

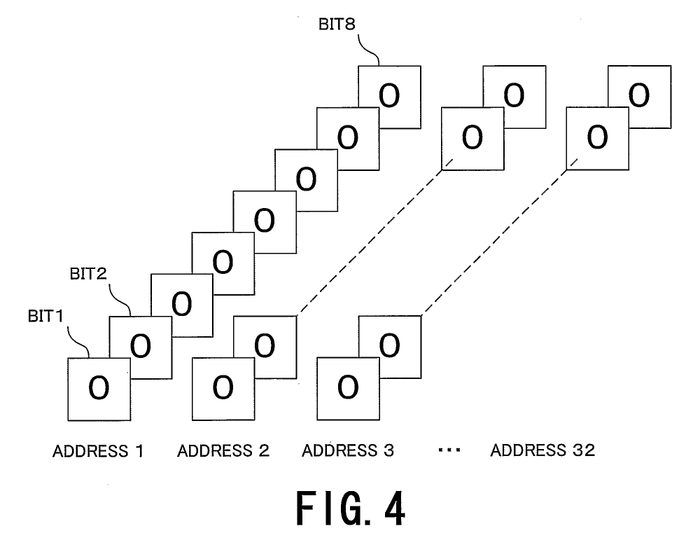

FIG. 4 shows one example of the structure of the BSI in a case where the total number of blocks of the flash memory 11 is 256. As shown in FIG. 4, the BSI is made up of 32-byte data. The respective bits of the data are associated in one-to-one correspondence with the blocks 0 to 255 sequentially from the top bit. Each one bit of the data is set to “1” when the corresponding block is being a vacant block and is set to “0” when the corresponding block is not being a vacant block.

The computer 2 is, for example, a personal computer or the like. The computer 2 causes the CPU 121 to access the flash memory 11. The computer 2 supplies data to be written in the flash memory 11. The computer 2 obtains data which the CPU 121 reads from the flash memory 11 to supply to the computer 2, form the CPU 121.

### (Operation)

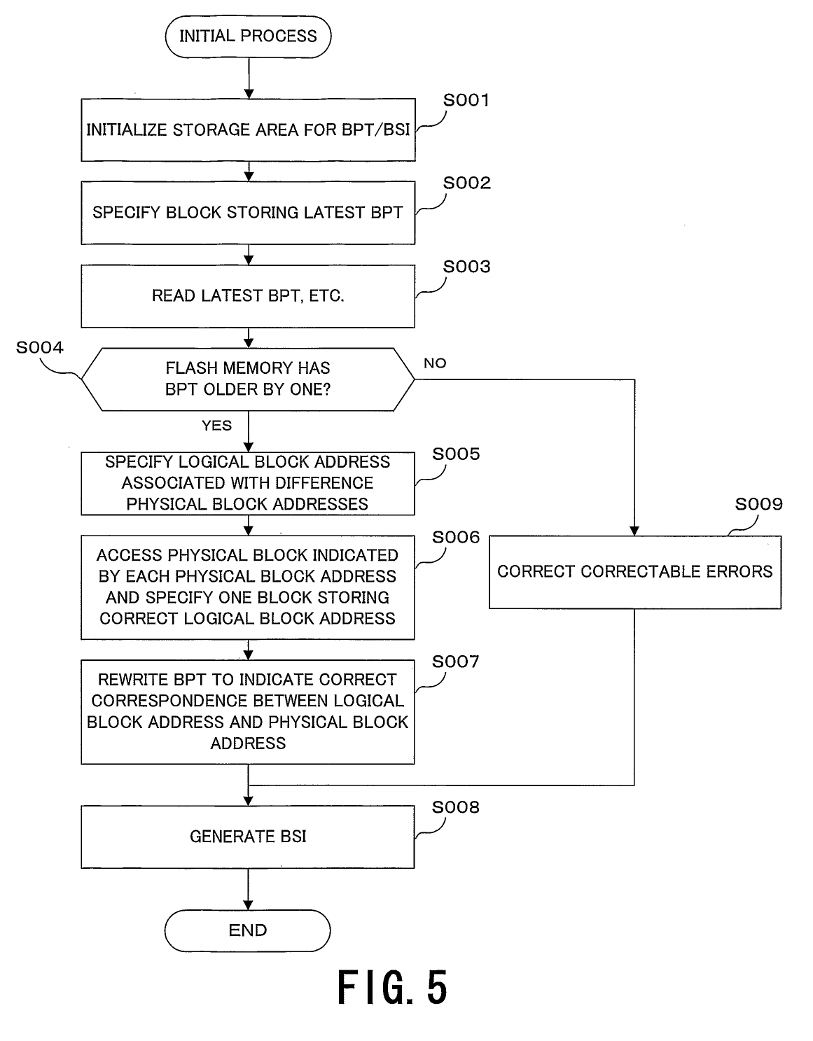

Next, operations of the present storage system will be explained with reference to FIG. 5 to FIG. 10.

### (Initial Process)

When the present storage system is activated, the CPU 121 of the controller 12 of the memory unit 1 performs the initial process shown in FIG. 5.

When the initial process is started, the CPU 121 initializes the storage area of the RAM 123 in parts where the BPT and the BSI are to be stored (FIG. 5, step S1001). Specifically, for example, the CPU 121 may set the logical values of all the bits in the part where the BPT or the BSI is to be stored in the storage area of the RAM 123 to “0”.

Next, the CPU 121 searches among the writing counters in the data areas of the top pages of the respective blocks of the flash memory 11 other than defective blocks thereof. Thereby, the CPU 121 specifies a BPT block in which the latest BPT is stored (step S002).

Next, the CPU 121 specifies the most-lately appearing page in which the BPT is written in its data area, among the pages included in the block specified at step S002. Then, the CPU 121 reads the BPT from the data area of the page as specified.

The CPU 121 reads the error correction code from the redundant area of the specified page. The CPU 121 stores the error correction code in the storage area of the RAM 123 (step S003).

Next, the CPU 121 searches the storage area of the flash memory 11. Then, the CPU 121 determines whether or not a BPT that is older by one than the BPT (hereinafter referred to as current BPT) read at step S003 is stored in the flash memory 11 (step S004).

In a case where it is determined that no such BPT is stored (step S004; NO), the CPU 121 corrects correctable errors included in the current BPT stored in the RAM 123 (step S009). This correction is done in accordance with a known method using the error correction code read at step S003. Then, the CPU 121 moves the flow to step S008.

The BPT which is older by one than the current BPT is specifically a BPT which meets the following rules (a) or (b).

(a) In a case where the current BPT is not stored in the top page of a block, an old BPT that is stored in a page whose page address is smaller by one than that of the page in which the current BPT is stored, is the BPT older by one than the current BPT.

(b) In a case where the current BPT is stored in the top page of a block, the BPT older by one is specified by the value of the previous page pointer stored in the current BPT.

That is, in a case where a BPT is included in a physical block indicated by the value of the previous page pointer, the BPT stored in the page indicated by this previous page pointer is the BPT older by one than the current BPT. In a case where the current BPT does not include a previous page pointer showing an effective value, or in a case where the physical block indicated by the previous page pointer includes no BPT, these are the case where no BPT that is older by one is stored in the flash memory 11.

To the contrary, in a case where the CPU 121 specifies a BPT older by one than the current BPT and determines that the BPT older by one is stored in the flash memory 11 (step S004; YES), the CPU 121 searches through the BPT older by one and the current BPT stored in the RAM 123. The CPU 121 specifies any logical block address that is associated with different physical block addresses in the two BPTs, from the respective BPTs (for each such logical block address, two physical block addresses are specified from the current BPT and BPT older by one, respectively) (step S005).

The CPU 121 specifies which of the two physical block addresses is associated correctly with the logical block address. First, the CPU 121 accesses the physical blocks indicated by the two physical block addresses. Then, the CPU 121 specifies one physical block in whose data area user data is stored and in whose redundant area the correct logical block address is written (step S006).

In a case where neither of the two physical blocks stores user data in its data area, or stores the correct logical block address in its redundant area, the logical block address concerned has no associated physical block address. In which case, accordingly, the CPU 121 rewrites the current BPT so as to associate the above-described predetermined value (“FFFFh”), which represents the inexistence of an associated physical block address, with the logical block address concerned. Then, the CPU 121 erases (flash-erases) the contents in all the pages of the two physical blocks.

Next, in a case where the physical block specified at step S006 is a block which is specified from the BPT older by one, the CPU 121 rewrites the current BPT stored in the RAM 123 so that the physical block address indicating the block specified at step S006 will be associated with the correct logical block address (step S007). In this rewriting, any of the logical block address read from the BPT older by one, and the logical block address read from the redundant area of the physical block may be used.

Then, the CPU 121 advances the flow to step S008.

At step S008, the CPU 121 generates the BSI. Specifically, the CPU 121 reads data stored in the redundant area of a page of each block of the flash memory 11 sequentially (for example, in the order of the block having the top physical block address to the block having the last physical block address, sequentially block by block). The CPU 121 determines whether the block from which data is read is a vacant block or not based on the read data, each time the data is read from a block. Specifically, the CPU 121 determines whether no defective block flag is stored, and no logical block address is stored in the redundant area of the read page. Then, the CPU 121 adds the result of this determination in the BSI stored in the RAM 123 (for example, if the block concerned is a vacant block, the value of the bit corresponding to this block in the BSI is set to “1”, whereas if the block is not a vacant block, the value of the bit is maintained as “0”).

When the generation of the BSI is completed, the storage system ends the initial process.

In accordance with the above-described initial process, the current BPT is transcripted to the storage area of the RAM 123 to be updated to hold a correct content, and the BSI is generated.

### (Data Reading Process)

When the initial process is completed, the CPU 121 is ready to receive an instruction for access to the flash memory 11 from the computer 2.

The computer 2 supplies a command for instructing reading of user data, and a logical block address and page address indicating the page to read from, to the controller 12. The CPU 121 of the controller 12 searches the BPT by using the supplied logical block address as the key. The CPU 121 searches out a physical block address that is associated with the supplied logical block address. Then, the CPU 121 reads data from the page which is specified by the searched-out physical block address and the page address supplied from the computer 2. The CPU 112 supplies the read data to the computer 2.

As a result, data is read from the flash memory 11 and supplied to the computer 2.

There is some case where the storage area of the flash memory 11 complies with the file system of MS-DOS (Registered Trademark). In such a case, the flash memory 11 pre-stores, for example, a directory and an FAT (File Allocation Table). The computer 2 causes the CPU 121 to read the directory and FAT first to obtain these, before reading the user data. The computer 2 specifies the page address of the page to read from and the logical block address of the block to which the page belongs, based on the obtained directory and FAT. In this case, for example, the block in which the directory and the FAT are stored is assigned a predetermined logical block address.

### (Data Writing Process)

In a case where data is to be written in the flash memory 11, the computer 2 first supplies a command for instructing writing of data in the flash memory 11 to the controller 12. Simultaneously, the computer 2 supplies the logical block address and page address of the page in which the data to be written is to be stored.

There might be a case where the storage area of the flash memory 11 complies with the file system of MS-DOS, and pre-stores a directory and an FAT. In such a case, the computer 2 first obtains the directory and FAT from the memory unit 1. Then, the computer 2 specifies the page address and logical block address of a page in which no data is stored, based on the obtained directory and FAT. The computer 2 updates the directory or FAT so that the specified logical block address will be registered in the directory or FAT. The computer 2 writes back the updated directory or FAT to the flash memory 11.

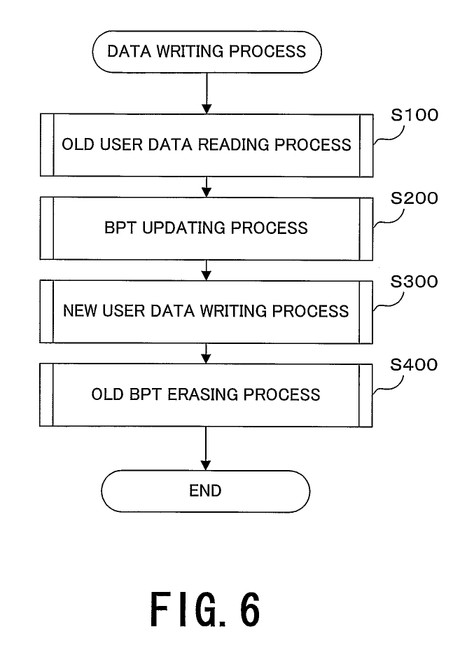

When supplied from the computer 2 with the command for instructing writing of data and the logical block address and page address, the memory unit 1 performs an old user data reading process first to check whether the instructed writing is overwriting or new writing (FIG. 6, step S100).

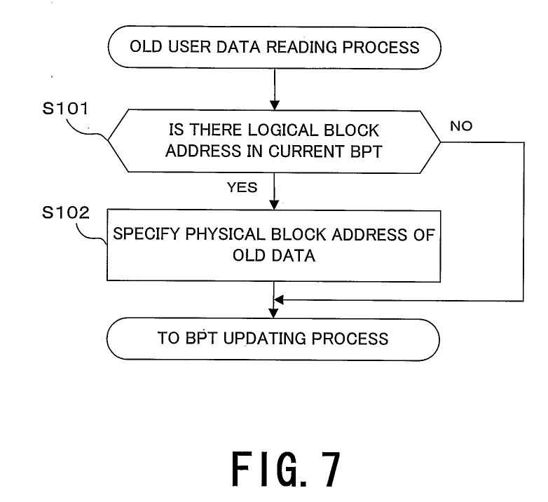

FIG. 7 shows the old user data reading process. First, the CPU 121 searches the BPT in the RAM 123 by using the logical block address supplied from the computer 2 as the key (step S101). In a case where the logical block address used as the key is present in the BPT (step S101; YES), the CPU 121 determines that the instruction is for overwriting of old data, and specifies the physical block address which is associated with the logical block address (step S102). Then, the flow goes to a BPT updating process (FIG. 6, step S200).

In a case where the logical block address used as the key is not present in the BPT (step S101; NO), the flow goes to the BPT updating process (FIG. 6, step S200).

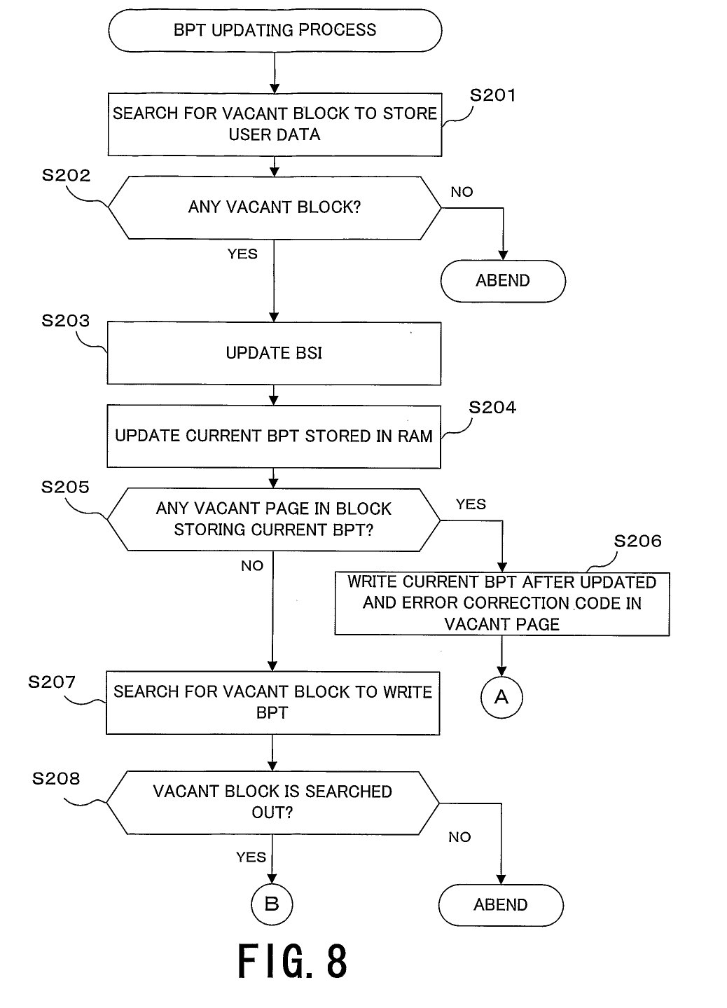

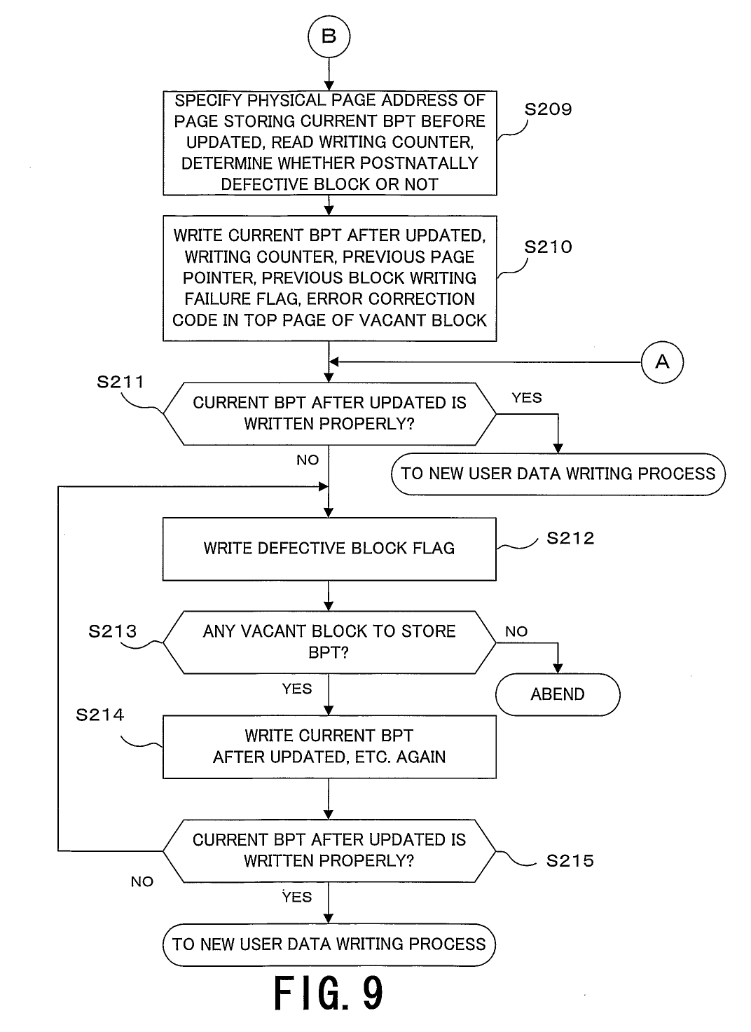

FIG. 8 and FIG. 9 show the BPT updating process. First, the CPU 121 searches for one vacant block in which user data is to be newly written (FIG. 8, step S201). Then, the CPU 121 determines whether any vacant block has been searched out or not (step S202). In a case where it is determined that no vacant block has been searched out (step S202; NO), the CPU 121 determines that there is not vacant block and writing cannot be performed. Then, the CPU 121 abends the data writing process.

To the contrary, in a case where it is determined that a vacant block has been searched out (step S202; YES), the CPU 121 updates the BSI so that it will indicate that the searched-out vacant block is no longer a vacant block thereafter (step S203). Further, the CPU 121 updates the BPT stored in the RAM 123 so that the physical block address of the searched-out vacant block will be associated with the logical block address supplied from the computer 2 together with the command instructing writing of data (step S204).

Then, the CPU 121 determines whether or not there is any vacant page in which no BPT has been stored yet in the block which stores the current BPT before being updated (step S205). In a case where it is determined that there is a vacant page (step S205; YES), the CPU 121 writes the current BPT after being updated which is stored in the RAM 123, in the data area of the vacant page which appears after the page which stores the current BPT before being updated. The CPU 121 generates an error correction code for the current BPT after being updated. Then, the CPU 121 writes the generated error correction code in the redundant area of the page in which the current BPT after being updated is stored (step S206). Then, the CPU 121 moves the flow to step S211.

To the contrary, in a case where it is determined at step S205 that there is no vacant page (step S205; NO), the CPU 121 searches for a physical block address of one vacant block in which the BPT is to be newly written (step S207). The CPU 121 determines whether or not any vacant block has been searched out (step S208). In a case where it is determined that a vacant block has been searched out (step S208; YES), the CPU 121 updates the BSI in the same manner as taken at step S203. Then, the CPU 121 moves the flow to step S209 shown in FIG. 9. To the contrary, in a case where it is determined that no vacant block has been searched out (step S208; NO), the CPU 121 determines that writing of the BPT cannot be performed because there is not vacant block. Thus, the CPU 121 abends the data writing process.

At step S209, the CPU 121 specifies the physical page address of the page in which the current BPT before being updated is written. Further, the CPU 121 reads the writing counter stored in the top page of the block in which the current BPT before being updated is stored. Further, the CPU 121 determines whether the block storing the current BPT before being updated is a postnatally defective block or not (step S209).

Then, the CPU 121 writes the current BPT after being updated, which is stored in the RAM 123, in the data area of the top page of the vacant block searched out at step S207. Further, the CPU 121 writes the physical page address specified at step S209 in the data area of the top page as a new previous page pointer. Further, the CPU 121 increments the writing counter read at step S209 by 1 block. Then, the CPU 12 writes the incremented writing counter in the data area of the top page of the searched-out vacant block as a new writing counter. Further, at step S210, the CPU 121 generates an error correction code for the current BPT after being updated. Then, the CPU 121 writes the generated error correction code in the redundant area of the page in which the current BPT after being updated is written. Furthermore, at step S210, the CPU 121 generates a previous page writing failure flag based on the determination at step S209 of whether or not the block is a postnatally defective block. Then, the CPU 121 writes the previous page writing failure flag in the redundant area of the page in which the current BPT after being updated is written (step S210).

At step S21 1, the CPU 121 receives a writing completion signal which is to be sent to the CPU 121 after the BPT is written at step S206 or step S210, and reads the status of 25 the flash memory 11. Then, the CPU 121 determines whether the writing at step S206 or step S210 has been performed properly or not, based on the read status (step S21 1). In a case where it is determined that the writing has been performed properly (step S211; YES), the CPU 121 goes on to a new user data writing process (FIG. 6, step S300).

To the contrary, in a case where it is determined at step S211 that the writing has not been performed properly (step S211; NO), the CPU 121 determines that the block in which the writing at step S206, step S210, or step S214 to be described later has not been performed properly is a postnatally defective block. Then, the CPU 121 writes a defective block flag in the redundant area of a page in that block (step S212).

Then, the CPU 121 retries writing the current BPT after being updated. For this purpose, the CPU 121 performs substantially the same procedures as step S207 and step S208 (step S213). If no vacant block is searched out at step S213, the CPU 121 abends the data writing process (step S213; NO). If a vacant block is searched out (step S213; YES), the CPU 121 performs substantially the same procedure as step S210. That is, the CPU 121 writes the current BPT after being uploaded, the previous page pointer, the writing counter, and the error correction code (step S214).

Then, the CPU 121 determines whether the writing at step S214 has been performed properly or not in the same manner as taken at step S211. In a case where it is determined that the writing has been performed properly (step S215; YES), the CPU 121 goes on to a new user data writing process (FIG. 6, step S300). To the contrary, in a case where it is determined at step S215 that the writing has not been performed properly (step S215; NO), the CPU 121 moves the flow to step S212.

Writing of user data is performed in accordance with, for example, a method disclosed in Unexamined Japanese Patent Application No. H11-112222 (Unexamined Japanese Patent Application KOKAI Publication No. 2000-305839).

The memory unit 1 receives data for one page and the logical block address and page address of a page in which the data is to be written from the computer 2, and stores the received data and addresses in the RAM 123. Next, the CPU 121 searches the BPT after being updated to specify a writing target physical block address that is associated with the logical block address. Then, the CPU 121 sets the physical page address of the top page of the specified physical block to be a writing target physical page address. Next, the CPU 121 determines whether or not any old physical block has been specified at step S100 that has been determined as will be overwritten.

In a case where no physical block has been specified (i.e., in case of new writing), the CPU 121 regards the logical page address received from the computer 2 as the writing target physical page address as set above. Then, the CPU 121 writes the data for one page and logical block address stored in the RAM 123, in the page of the flash memory 11 that is indicated by the writing target physical page address.

In a case where an old physical block has been specified at step S100, the CPU 121 determines whether the logical page address to which data is to be written from the computer 2 corresponds to the writing target physical page address or not. In a case where they do not correspond to each other, the CPU 121 copies the content of a page indicated by a page address of the old physical block, in the page indicated by the writing target physical page address. After this, the CPU 121 sets the address of the next page in the physical block specified from the BPT after being updated, to be the writing target physical page address. Thereafter, the CPU 121 repeats the same copying operation until the logical page address to which data is to be written corresponds to the writing target physical page address. When they finally correspond to each other, the CPU 121 writes the data for one page and logical block address having been stored in the RAM 123, in the page of the flash memory 11 indicated by the writing target physical page address.

Next, the CPU 121 determines whether or not the data written now has continued data to be written in the next page, and receives data for one page from the computer 2 in the RAM 123 in a case where there is such continued data. Then, the CPU 121 sets the address of the next page to be the writing target physical page address. The CPU 121 writes the data for one page and logical block address stored in the RAM 123, in a page of the flash memory 11. In a case where there is no such continued data, the CPU 121 continues copying from the pages in the old physical block until the writing target physical page address reaches the last page address in the target block. When writing is completed in the page which is set to be the writing target physical page address lastly in the block, the CPU 121 erases the old physical block.

The CPU 121 moves on to an old BPT erasing process, after the writing of the user data is completed (step S400).

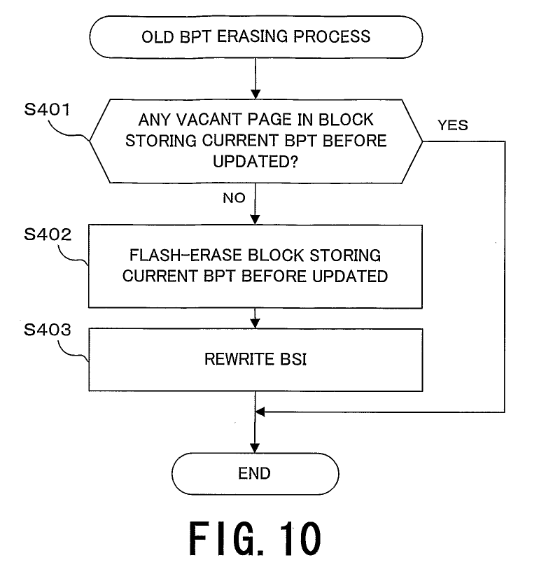

FIG. 10 shows the old BPT erasing process. First, the CPU 121 determines whether or not it has determined at step S205 that there is a vacant page in the block which stores the current BPT before being updated (old BPT) (FIG. 10, step S401). In a case where it has determined that there is a vacant page (step S401; YES), the CPU 121 terminates the data writing process on the whole. To the contrary, in a case where it has determined that there is no vacant page (step S401; NO), the CPU 121 flash-erases the block which stores the old BPT. Then, the CPU 121 sets an initial value representing that the block is a vacant block, in the redundant area of a page which belongs to the block whose data has been erased (step S402). Then the CPU 121 accesses the BSI to rewrite the BSI to indicate that the block whose data has been erased at step S402 is a vacant block (step S403). Then, the CPU 121 terminates the data writing process on the whole.

As explained above, the present storage system records the previous page pointer and the writing counter in the block which stores the BPT, as long as it functions correctly. Further, the present storage system continuously stores past BPTs.

Then, in a case where a current BPT or user data is not correctly stored in the flash memory 11 because of a power failure, etc., during the writing process, the present storage system specifies a BPT older by one, using the previous page pointer. Then, the present storage system determines the correct content of the BPT, using the current BPT and the BPT older by one as specified. Further, in a case where the BPT most lately generated is not specified by the controller 12 as the current BPT for some reasons such as it having been greatly destroyed, etc., a latest BPT that has the correct content as BPT is specified as the current BPT.

Accordingly, even if a trouble occurs while the user data is being written or the address translation table is being updated, the present storage system can properly perform reading and writing even after such a trouble.

The structure of the present storage system is not limited to the above-described one.

For example, the number of blocks in the storage area of the flash memory 11, the number of pages in each block, the storage capacity of each page, and the storage capacity of the data area and redundant area are arbitrary. Further, the flash memory 11 needs not be an EEPROM. The flash memory 11 may be an arbitrary storage device that is readable and writable by a computer.

Further, the BPT older by one may be specified by using the writing counter or the previous block writing failure flag.

Further, in a case where the BPT older by one cannot be specified by using the previous page pointer, the writing counter, or the previous block writing failure flag, the controller 12 may specify one of the past BPTs as the BPT older by one, in accordance with an arbitrary rule.

The embodiment of the present invention has been explained as above. The storage device and memory managing apparatus of the present invention can be realized not by a dedicated system, but by an ordinary computer system. For example, if a personal computer to be connected to the flash memory 11 has a medium (a flexible disk, a CD-ROM, etc.) storing a program for executing the above-described operations of the controller 12 and computer 2, and the program is installed from the medium, a storage system capable of performing the above-described processes can be constructed.

Further, for example, the program may be uploaded to a bulletin board system (BBS) of a communication network to be distributed through the communication network. Then, by the program being activated and executed in the same manner as other application programs under the control of an OS (Operating System), the above-described processes can be performed.

In a case where the OS takes charge of a part of the processes, or in a case where the OS constitutes a part of one structural element of the present invention, a program from which such a part is excluded may be stored in the recording medium. Even in this case, according to the present invention, a program for realizing each function or each step to be executed by the computer is stored in the recording medium.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2005-104207 filed on Mar. 31, 2005 and including specification, claims, drawings and summary. The disclosure of the above Japanese Patent Application is incorporated herein by reference in its entirety.

1. A storage device, comprising:
a storage unit which includes a plurality of memory blocks for storing user data each of which is assigned a physical address, and stores a current address translation table indicating correspondence between the physical addresses of the memory blocks and logical addresses thereof; and
a writing unit which receives user data to be written and a logical address, specifies a vacant page in which the user data can be stored, from pages which constitute a memory block, writes the user data to be written in the specified vacant page, and stores a new current address translation table indicating correspondence between the physical addresses and logical addresses of the memory blocks after the user data is written, in said storage unit,
wherein:
said storage unit continuously stores a past address translation table which has been the current address translation table until immediately before the new current address translation table is stored; and
said writing unit adds previous table information indicating a page in which the past address translation table is stored to the new current address translation table, and stores the resultant new current address translation table in said storage unit.

2. The storage device according to claim 1,
wherein said writing unit specifies a location of the past address translation table based on the previous table information, and corrects a content of the current address translation table based on the past address translation table whose location is specified.

3. The storage device according to claim 1,
wherein said writing means specifies any logical address whose correspondence with a physical address in an address translation table older by one, which is specified based on the previous table information, is different from whose correspondence with a physical address in the current address translation table by referring to the these address translation tables, determines which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, corrects the current address translation table so as to indicate the determined correct correspondence.

4. The storage device according to claim 1,
wherein in a case where said writing unit stores the new current address translation table in a memory block which has not stored any address translation table yet, said writing unit adds block use order information indicating an order at which the memory block is started to be used as a memory block for storing an address translation table to the new current address translation table, and stores the resultant new current address translation table in said storage unit.

5. The storage device according to claim 4,
wherein said writing unit specifies a location of the past address translation table based on the block use order information, and corrects a content of the current address translation table based on the past address translation table whose location is specified.

6. The storage device according to claim 4,
wherein said writing unit specifies any logical address whose correspondence with a physical address in an address translation table older by one, which is specified based on the block use order information, is different from whose correspondence with a physical address in the current address translation table by referring to the these address translation tables, determines which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, corrects the current address translation table so as to indicate the determined correct correspondence.

7. The storage device according to claim 4,
wherein said writing unit may store an address translation table in a vacant page in accordance with an order of each page in a memory block assigned to each page, and when said writing unit stores the new current address translation table in a memory block which has not stored any address translation table yet, said writing unit adds previous table storing block status information indicating whether a memory block which stores the past address translation table is a defective block or not, to the new current address translation table, and stores the resultant new current address translation table in said storage unit.

8. The storage device according to claim 7,
wherein said writing unit specifies a location of the past address translation table based on the block use order information and the previous table storing block status information, and corrects a content of the current address translation table based on the past address translation table whose location is specified.

9. The storage device according to claim 7,
wherein said writing unit specifies any logical address whose correspondence with a physical address in an address translation table older by one, which is specified based on the block use order information and the previous table storing block status information, is different from whose correspondence with a physical address in the current address translation table by referring to the these address translation tables, determines which of the address translation table older by one and the current address translation table stores a correct correspondence between the logical address and the physical address based on logical addresses stored in physical blocks indicated by the two physical addresses respectively, and in a case where determining that the address translation table older by one stores the correct correspondence, corrects the current address translation table so as to indicate the determined correct correspondence.

10. A memory managing apparatus for storing user data to be written, in a memory including a plurality of memory blocks for storing the user data each of which memory blocks is assigned a physical address, and for storing in said memory a current address translation table indicating correspondence between the physical addresses of the memory blocks and logical addresses thereof, said apparatus comprising:
a user data writing unit which receives user data to be written and a logical address, specifies a vacant page in which the user data can be stored, from pages constituting a memory block, and writes the user data to be written, in the specified vacant page; and
a table writing unit which stores a new current address translation table indicating correspondence between the physical addresses and logical addresses of the memory blocks after writing by said user data writing unit is performed, in said memory,
wherein:
said memory continuously stores a past address translation table which has been the current address translation table until immediately before the new current address translation table is stored; and
said table writing unit adds previous table information indicating a page in which the past address translation table is stored to the new current address translation table, and stores the resultant new current address translation table in said memory.

11. A memory managing method for storing user data to be written, in a memory including a plurality of memory blocks for storing the user data each of which memory blocks is assigned a physical address, and for storing in said memory a current address translation table indicating correspondence between the physical addresses of the memory blocks and logical addresses thereof, said method comprising:
a user data writing step (S300) of receiving user data to be written and a logical address, specifying a vacant page in which the user data can be stored, from pages constituting a memory block, and writing the user data to be written, in the specified vacant page; and
a table writing step (S200) of storing a new current address translation table indicating correspondence between the physical addresses and logical addresses of the memory blocks after writing at said user data writing step (S300) is performed, in said memory,
wherein:
said memory continuously stores a past address translation table which has been the current address translation table until immediately before the new current address translation table is stored; and
at said table writing step (S200), previous table information indicating a page in which the past address translation table is stored is added to the new current address translation table, and the resultant new current address translation table is stored in said memory.

12. A computer readable storage media which stores the program for controlling a computer to function as a memory managing apparatus for storing user data to be written, in a memory including a plurality of memory blocks for storing the user data each of which memory blocks is assigned a physical address, and for storing in said memory a current address translation table indicating correspondence between the physical addresses of the memory blocks and logical addresses thereof, said apparatus comprising:
a user data writing unit which receives user data to be written and a logical address, specifies a vacant page in which the user data can be stored, from pages constituting a memory block, and writes the user data to be written, in the specified vacant page; and
a table writing unit which stores a new current address translation table indicating correspondence between the physical addresses and logical addresses of the memory blocks after writing by said user data writing unit is performed, in said memory,
wherein:
said memory continuously stores a past address translation table which has been the current address translation table until immediately before the new current address translation table is stored; and
said table writing unit adds previous table information indicating a page in which the past address translation table is stored to the new current address translation table, and stores the resultant new current address translation table in said memory.
